(19) United States
(12) Patent Application Publication
(10) Pub. No.: US 2004/0187496 A1
(43) Pub. Date: Sep. 30, 2004

(54) Mark BELA-I solar engine

(76) Inventors: Anatoly Blank, Brooklyn, NY (US); Emil Blank, Brooklyn, NY (US); Leonid Blank, Brooklyn, NY (US)

Correspondence Address: Anatoly Blank, 2728 East 23rd Street, Brooklyn, NY, 11235, US

(21) Appl. No.: 10/401,965

(22) Filed: Mar. 31, 2003

(51) Int. Cl. F03G 6/00; F03G 7/00; B60L 8/00; B60K 16/00

(52) U.S. Cl. 60/641.8; 60/641.15

(57) ABSTRACT

The Mark BELA-I Solar Engine converts solar energy into continuous mechanical movement.

The BELA-I Solar Engine comprises a set of the following units:

(1) Solar concentrator

(2) Air heating radiator

(3) Piston steam engine.

The latter works on a shuttle action principle which is effected by providing a hydraulic link between each pair of cylinder blocks. The hydraulic link in all the cylinder pairs is effected by connecting each pair of cylinders by means of two parallel tube connectors. Each of these connectors is provided with two valves, whereby one of the valves is controlled by the camshaft rocker, while the other (the so-called “normally-open” valve) is closed only by the pressure of steam from the inside of its cylinder.

### 2) FIELD OF THE INVENTION

The Mark BELA-I Solar Engine can be used for electricity supply and in transport vehicles. Such a span of utility of the BELA-I solar energy steam converter is possible owing to the idea of the use of steam working in a shuttle mode. The shuttle mode of operation consists in the engine working without any consumption of steam at great influx of solar energy. Under such operating mode solar energy heats constantly one and the same volume of working steam.

The Mark BELA-I Solar Engine can also be coupled directly to an electric generator or be used in conjunction with an internal combustion engine to actuate the same crankshaft of a transport vehicle.

### 3) DESCRIPTION OF PRIOR ART

At present solar energy converters are being designed, principally, for the needs of low-voltage engineering, in which solar energy is utilized as photoelectric effect. Besides, solar energy is widely used in hotbed facilities and in household water heaters. It is known that there are major spherical mirror concentrators of solar energy, but analysis of patent material on the subject did not reveal their actual use for generation of continuous mechanical motion.

Of some interest is the idea presented in U.S. Pat. No. 6,080,927 Jun. 27, 2000 comprising a mechanism for tracing the direction of solar rays with the aim of proper guiding and obtaining optimum heating utilization.

### 4) BACKGROUND OF THE INVENTION

It is commonly known that spherical mirrors and collective glass lenses are capable to concentrate solar rays, whereby great heating effect is obtained. The principal restraining factors for a wide use of this effect are the design and principle of action of heat engines which demand, for instance, great consumption of steam to convert solar energy into mechanical movement.

Everything described above makes the use of solar energy for continuous mechanical movement a complicated task, i.e. a design of an engine with low steam consumption and, accordingly, a suitable solar concentrator.

### 5) SUMMARY OF THE INVENTION

The Mark BELA-I Solar Engine comprises a set of mechanisms containing cylinder blocks with any even number of cylinders. Included in these mechanisms are:

(a) Cylinder block(s);

(b) Mechanism for converting linear movement of pistons into rotary motion of the main shaft;

(c) Camshaft with rockers and valves;

(d) Starter with battery;

(e) Solar concentrator;

(f) Air heating radiator coil;

(g) Air blower;

(h) Crankshaft.

A special feature of the design of said solar engine is that it allows the engine to be engaged in a shuttle mode of action almost without any consumption of steam. Besides, the proposed solar engine is compatable with an internal combustion engine, which widens the field of its application.

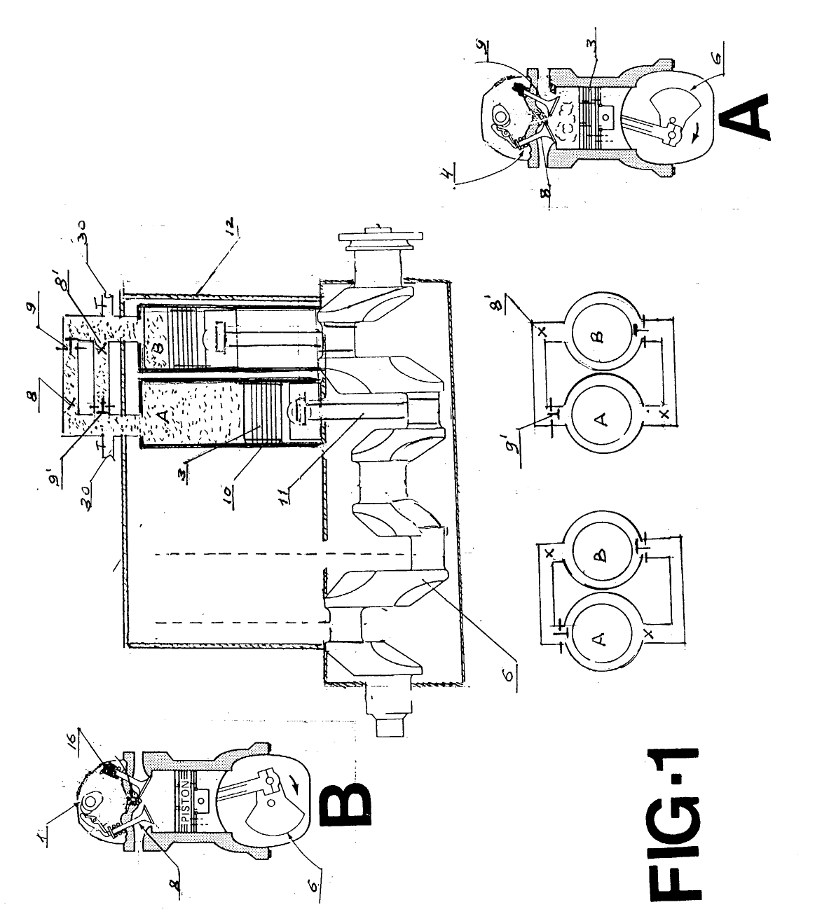

The dynamics of the shuttle mode principle of converting BELA-I solar energy consumption into continuous mechanical motion (during sunny periods) can be traced by means of a conventional schematic drawing (FIG. 1).

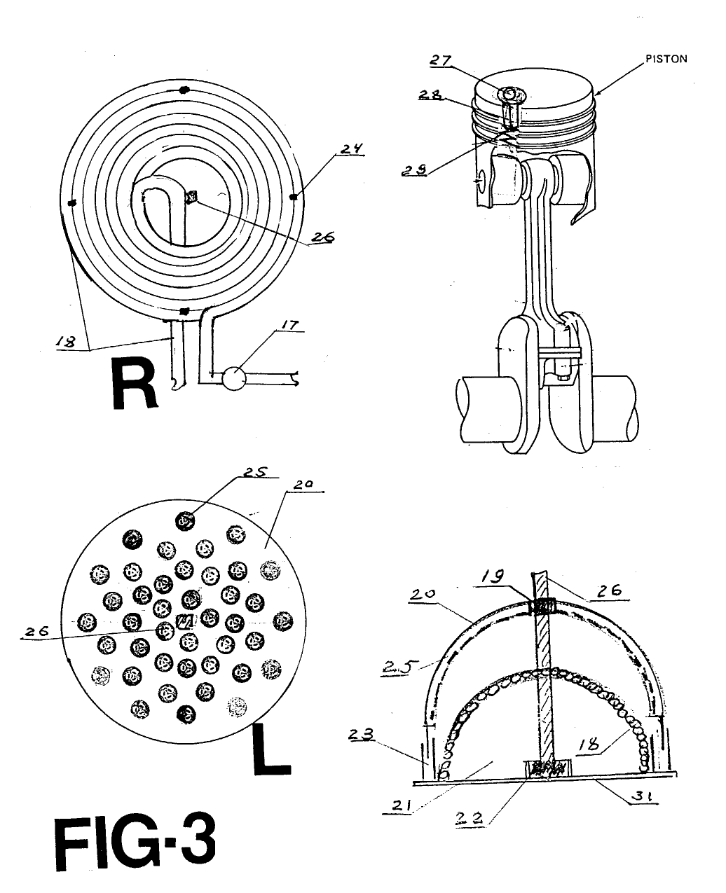

Some quantity of air, heated up to the highest possible temperature, is forced from the solar concentrator radiator (FIG. 3) to the space under the valve cover and into the cylinder block jacket. The water contained in one of the cylinders (for instance, cylinder A) is heated by this air up to the boiling point and, through one of the opened camshaft valve 8 (FIG. 1) the steam bursts through the normally-open valve 9 into another cylinder (B), thus moving the piston of that cylinder downward and starting the rotation of the crankshaft, which action forces piston 3 of cylinder to be moved up to its stop. At this moment the camshaft opens valve 8′ and closes valve 8. The steam pressure in cylinder B exerts pressure through valve 9′ on the previously risen piston in cylinder A, thus forcing it downward. While this is in progress, the outlet of steam through valve 9′ is shut off. When valve 8 opens by the camshaft, then the cycle will be repeated, and so on.

During the whole period of the shuttle operation the temperature of air in the radiator is being maintained by solar heating at the level of the initial temperature.

### 6) DESCRIPTION OF THE PREFERRED EMBODIMENTS

The Mark BELA-I Solar Engine may preferrably be used for electric power supply, both as a local variant (during sunny periods) and in conjunction with a wind-helium electric set. Besides, the BELA-I Solar Engine can be used as a mover in a transport vehicle being coupled to an internal combustion engine to drive the common crankshaft (to save fuel).

When engaged as a local variant for electric power supply, the solar engine is used as a direct drive of an electric generator. When working in conjunction with a wind-helium electric set, the solar engine is coupled as a drive to one of the air compressors.

### 7) BRIEF DESCRIPTION OF THE DRAWINGS

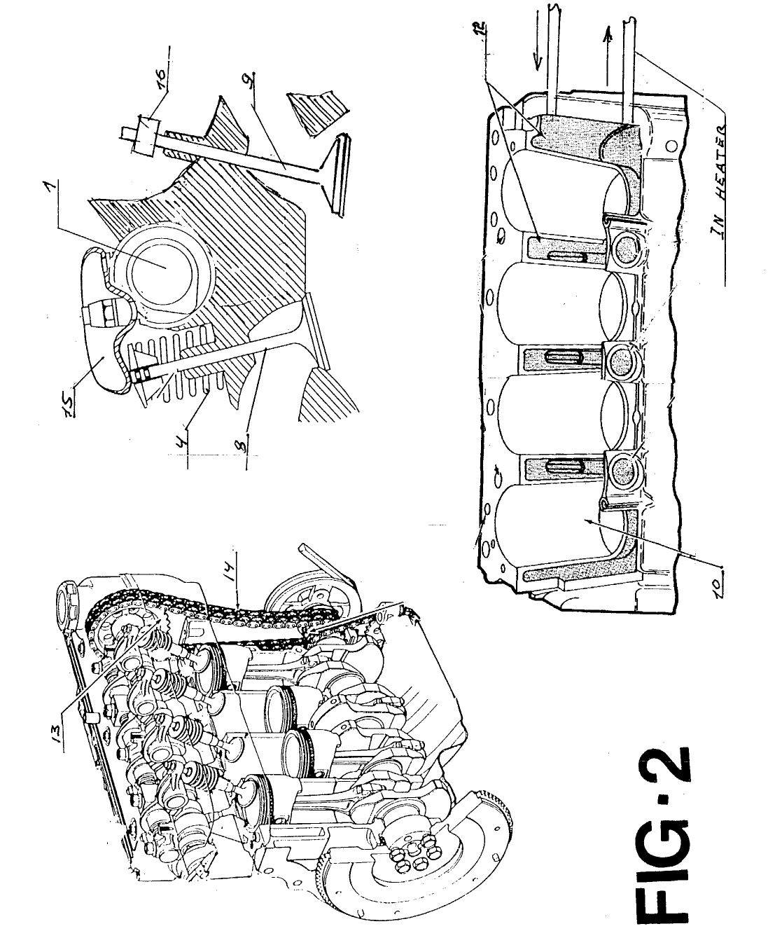

In its design the Mark BELA-I Solar Engine is a cylinder block (FIG. 1) with any even number of cylinders. The valve cover forms an enclosed space over the valves, which, together with cylinder block jacket 12 around the cylinders represents a volume connected through pipes with the coil radiator of solar concentrator 18 (FIG. 3R). Forced air circulation between the cylinder block and the radiator is effected by pump 17. The lower part of the cylinder block contains a crankshaft 6, and the camshaft 1 is located at the top. The cylinders are fitted with pistons 3 linked by means of connecting rods 11 with the crankshaft 6. Each piston 3 is fitted with a calibrated valve 28 which is normally closed by spring 29 and serves to release excessive pressure of steam through port 27 in the piston. At the top of each cylinder (FIG. 2) there are two valves 8 and 9. One of them (8) is controlled by camshaft 1 through rocker 15 and spring 4. The other valve (9), the so-called normally-open valve), is not controllable from the camshaft, but it has a balance weight 16 on its stem owing to which it is always open, and it closes only by the pressure of steam in the cylinder. All the cylinders are interconnected in pairs by two parallel tube connectors, which connect the valve outlets from the cylinders, whereby the controlled valves 8 and 8′ are each communicated with respective valves 9 and 9′.

The amount of air being heated to a high temperature in radiator 18 (FIG. 3,R) is constantly pumped between radiator 18 and space 12 by the air pump 17. The solar concentrator is situated outside the cylinder block. In the BELA-I system the solar concentrator is designed a spherical segment with a bottom 31 (see FIG. 3). On top of the shperical surface there is a tight tube arrangement comprising a metal tube radiator 18 with an air pump 17 at one of its outlets. Mounted over radiator 18 is a spherical multilens cover 20 (FIG. 3, L) arranged at the effective focusing range of the lenses from the radiator and attached to the spherical segment bottom by means of a micrometric screw 26 and a telescopic rim 23 (FIG. 3) on the circumference. At the base the micrometric screw is fitted with a reversible electric motor complete with a reduction gear 22 (FIG. 3). Fitted in the multilens cover is a stationary nut 19 (FIG. 3) into which the micrometric screw is turned in and out, thus adjusting the clearance between the radiator and the lenses. Mounted at some characteristic points in the same plane with the radiator are thermocouples 24 (FIG. 3) the readings of which serve to automatically adjust an optimum clearance between spheres 20 and 21. The tube connectors between the cylinders are fitted with valve 30 (FIG. 1) for the routine adding of water into the cylinders.

What is claimed:

I. A BELA-I Solar Engine consists of a combination of the following units:
1) A cylinder block with any even number of cylinders, valves, pistons, camshaft, crankshaft, a mechanism for converting linear movement of pistons into rotary motion of crankshaft, and tube connectors communicating in pairs every two cylinders through valve ports.
2) A multilens spherical solar concentrator located over hermetically sealed spherical segment on the top of which there is a tightly fitted tubular radiator. The multilens spherical solar concentrator is connected with the spherical radiator segment through a central pin which, in fact, is a micrometer screw fitted with a reversible electric motor. On the outside the multilens concentrator and the radiator segment are connected by a telescopic rim.

II. A solar engine as claimed in claim I (It.1), wherein each pair of said piston cylinders are interconnected by parallel table connectors, further each of them connecting the camshaft controlled valve of one cylinder with the uncontrolled open valve of the other cylinder. Besides, each piston is fitted with a gauged normally-closed emergency spring valve.

III. A solar engine as claimed in claim II, wherein a tubular radiator arranged on hermetically-sealed spherical segment, further equipped with an air blower providing for circulation of hot air between said radiator and air spaces in the cylinder block.

IV. A solar engine as claimed in claim II, wherein said multi-lens concentrator is connected with said spherical radiator segment through said micrometric screw, further said radiator is fitted with several thermocouples by the readings of which the clearance of focusing effect between lenses and radiator is automatically adjusted.
